(19) United States
(12) Patent Application Publication
(10) Pub. No.: US 2008/0108358 A1
(43) Pub. Date: May 8, 2008

(54) INTERFERENCE MITIGATION AND RECOVERY

(75) Inventors: Swetal A. Patel, Roselle Park, NJ (US); Steve H. Ostroff, Sunrise, FL (US); Amit Ramani, Coral Springs, FL (US); Philip A. Schentrup, Hollywood, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 11/557,731

(22) Filed: Nov. 8, 2006

(51) Int. Cl. H04Q 7/20

(52) U.S. Cl. 455/446

(57) ABSTRACT

A subscriber unit (107) operates in a communication system (100) with at least two servers (102, 103). The subscriber unit (107) receives a plurality of received signal samples that each include a color code value (304) identifying on cell server of a plurality of cell servers transmitting signals in a coverage area. The subscriber unit (107) then determines the best received color code value based on a quality/error metric derived from the received color codes associated with the received signal samples.

### BACKGROUND OF THE INVENTION

1. Field of the Invention

This invention relates in general to cellular communication systems, and more particularly to using color code information in a wireless device to mitigate interference of nearby cells.

2. Description of the Related Art

Wireless communication systems often support subscriber units distributed throughout a geographic area. Oftentimes, the geographic area is divided into wireless communication “cells,” each of which is serviced by a cell server. A mobile subscriber unit operating within the system may move from one cell to another cell. Preferably, a subscriber unit is handled by a particular cell server when the subscriber unit is within the geographic region serviced by the cell server. To support mobile subscriber units, the cell servers are ordinarily configured to provide overlapping geographic coverage. As a subscriber unit moves from one geographic area to another, the system provides a mechanism for transferring control of the subscriber unit from one cell server to another.

Subscriber units monitor the cell server transmissions in order to acquire cell service and to facilitate cell server switching operations. A color code, e.g., typically a four bit code, is periodically transmitted by each of the monitored cell servers to allow a subscriber unit to quickly identify the source of a monitored signal between different cells using the same frequency. The subscriber unit measures the quality of the cell server transmissions and identifies the proper cell server as the source of the signal transmission by using the color codes, which are unique transmitter identifiers, transmitted in association with the monitored signal.

Unfortunately, under certain conditions, the color code information may be corrupted. If the color code information associated with a base radio's signal transmission is missed by the subscriber unit it can not guarantee that it is seeing the desired cell.

Currently, to acquire a new cell server, the subscriber units monitor a control channel for several slots. Once the subscriber unit makes a decision to connect to a cell server the subscriber unit uses the last color code received to identify the cell server in the future. However, if a situation occurs where the final color code decoded before a subscriber unit decides to connect to a channel becomes corrupted, then the color code latched by the subscriber unit to identify the cell server will be incorrect and the subscriber unit will not be able to find the cell it is looking for. The cell it is in has a different color code than was latched by the subscriber unit and is viewed by the subscriber unit as being the incorrect cell. Thus, in this situation, the subscriber unit is unable to connect to a desired cell server.

Therefore a need exists to overcome the problems with the prior art as discussed above.

### SUMMARY OF THE INVENTION

Briefly, in accordance with the present invention, disclosed is a wireless communication device, or “subscriber unit,” with an input for receiving a plurality of samples that each include a color code value uniquely identifying a cell server in a plurality of cell servers, a processor communicatively coupled to the input, and a memory, electrically coupled to the processor. The memory stores computer instructions for operating the processor, the instructions comprising instructions for selecting one of the plurality of color codes based on a determination of a likeliest source of the received signal samples calculated by comparing to each other of the plurality of received color code values.

In accordance with an added feature of the invention, the determination of likeliest source of the received signal samples comprises determining which received color code value is present more than any other of the received color code values.

In accordance with an additional feature of the invention, the determination of a likeliest source of the received signal samples comprises comparing each received color code value against each other received color code value and determining that all of the plurality of received color code values are the same.

In accordance with yet another feature of the invention, the determination of a likeliest source of the received signal samples comprises comparing each received color code value against each other received color code value and determining that a majority of the plurality of received color code values are the same.

In accordance with yet a further feature of the invention, the determination of a likeliest source of the received signal samples comprises determining a signal quality of each of the received samples and weighing each color code value by the signal quality.

In accordance with yet an added feature of the invention, the color code value includes an estimate of signal quality.

In accordance with yet another added feature of the invention, the determination of a lowest error value comprises comparing at least one of the received color code values to a history received of color code values.

In accordance with yet an additional feature of the invention, the determination of a likeliest source of the received signal samples comprises determining a location of the subscriber unit, calculating a distance from the subscriber unit to a known location of at least one cell server, and comparing at least one of the received color code values to a known color code value associated with the at least one cell server.

In accordance with yet a further feature of the invention, the determination of a likeliest source of the received signal samples comprises determining a location of the subscriber unit and comparing at least one of the received color code values to a history of color code values previously received approximately at the determined location of the subscriber unit.

In accordance with again another feature of the invention, the selecting one of the plurality of received color code values comprises determining a location of the subscriber unit, determining a proximity from the subscriber unit to at least two neighbor cell servers in a neighbor cell list, and then selecting one of the received color code values that matches one of the at least two neighbor cell servers based on the determined proximity thereto.

In accordance with again a further feature of the invention, the memory includes further computer instructions for selecting the at least two neighbor cell servers from a neighbor cell list and selecting a second received color code value corresponding to a second one of the at least two neighbor cell servers in the neighbor cell list, the selection based on a next best determined proximity.

In accordance with still a further feature of the invention, the memory includes further computer instructions for connecting with one of the plurality of potential cell servers corresponding to the color code value determined to be present more than any other of the received color code values.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a time division multiple access (TDMA) wireless communication system, in accordance with embodiments of the present invention.

FIG. 2 is a more detailed block diagram of a subscriber unit in the system illustrated in FIG. 1, according to embodiments of the present invention.

FIG. 3 is a timing block diagram illustrating time slots allocated on receive and transmit channels in an exemplary three slot TDMA system, in accordance with embodiments of the present invention.

FIG. 4 illustrates a method for processing color code information and quality measurements of transmitted signals from nearby cell servers utilizing a DSP according to embodiments of the present invention.

FIG. 5 illustrates a method for processing color code information and quality measurements of transmitted signals from nearby cell servers utilizing a host processor 205 in accordance with embodiments of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

This invention utilizes a new method in a wireless communication system to significantly improve the process of validating the color code information associated with a monitored signal from cell servers, such as for a wireless communication device, or a “subscriber unit,” to have the information necessary to base acquire and cell server switching decisions. Generally, the wireless communication system, according to an embodiment of the present invention, provides a method for performing signal quality measurements in a time division multiple access (TDMA) cellular communication system. As will be discussed in detail below, one wireless communication system includes at least one subscriber unit that, according to the present invention, monitors color code information from cell servers and verifies service with a majority vote scheme. In another embodiment, the present invention provides a subscriber unit that verifies service with a channel quality sampling and rejection scheme.

TDMA System

A transceiver subscriber unit operating in a TDMA cellular system has a primary server and at least one other potential server. The subscriber unit has defined transmit and receive slots for communication with the primary server. The subscriber unit schedules signal quality measurements from one or more potential servers (from nearby and neighboring cells) based on system imposed transmission rules. For example, a particular system implementation may specify that a transmit slot and a receive slot are to be used in communication every third predefined time slot in a TDMA channel for a TDMA communication to be maintained via the primary server. Normally, a subscriber unit does not perform receive operations at the same time as it performs transmit operations, even though the receive and transmit operations typically use different channel frequencies.

In a three-to-one TDMA cellular system, during a maintained communication with the primary server, the subscriber unit may have less than one time slot out of every cycle of three time slots where the subscriber unit is not performing normal communication receive or transmit operations. This “idle time” normally is when the subscriber unit can monitor the quality of a neighbor cell server signal transmission.

Furthermore, the color code information from a neighbor cell server is typically located at a predefined portion of a time slot, such as in a header portion of the time slot. If the subscriber unit is not able to monitor a transmitted signal from a particular neighbor cell server within the header portion of a time slot, the subscriber unit may not detect the color code information associated with the particular neighbor cell server being monitored for signal quality. That is, the subscriber unit may not know the source of the transmitted signal that is being measured for signal quality.

Signal quality measurements for a potential server are scheduled based at least in part on a list of potential servers that are most likely candidates for receiving control of the subscriber unit. If a plurality of these likely candidates are also transmitting on the same channel frequency, the subscriber unit may not be able to differentiate between two or more of these candidates from the received signal. A switch over may be missed, or even worse, a call may be dropped. Therefore, according to preferred embodiments of the present invention, the new and novel methods discussed in detail below solve these problems to provide the subscriber unit the necessary color code information to base an acquire or cell-server-switching decision.

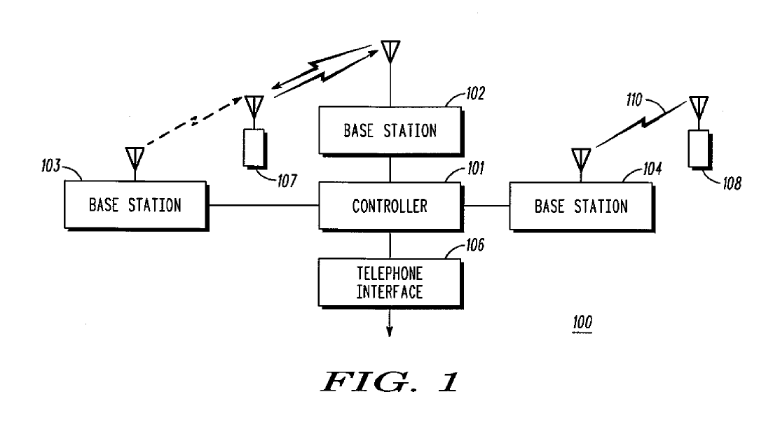

Referring now to FIG. 1, a block diagram of a wireless communication system 100 is shown, in accordance with a preferred embodiment of the present invention. The system 100 includes a controller 101 coupled to base stations 102, 103, 104, and interfaced to an external network through a telephone interface 106. The base stations 102, 103, 104 individually support portions of a geographic coverage area serving subscriber units or transceivers 107, 108. The subscriber units 107, 108 interface with the base stations 102, 103, 104 using a TDMA communication protocol.

The geographic coverage area of the communication system 100 is divided into regions or cells, which are individually serviced by the base stations 102, 103, 104, also referred to herein as cell servers. A subscriber unit operating within the system 100 selects a particular cell server as its primary interface for receive and transmit operations within the system. As a subscriber unit powers on or initially enters a service area, it searches for the best cell server of those within range to serve as this primary cell server. Similarly, when a subscriber unit moves between various geographic locations in the coverage area, a switch between cell servers may be necessary so that a new cell server will function as the primary cell server. For example, subscriber unit 107 has cell server 102 as its primary cell server, and subscriber unit 108 has cell server 104 as its primary cell server. Preferably, a subscriber unit selects a cell server which provides the best communication interface into the system. This ordinarily will depend on the signal quality of communication signals between a subscriber unit and a particular cell server. According to the present example, a subscriber unit monitors communication signals from several base stations servicing cells to determine the most appropriate cell server to act as the primary server.

Each cell server operates on one or more “control channels,” which are the frequencies it uses to communicate to the subscriber units. A first control channel at a first frequency is used for transmitting and a second control channel at a second frequency is used for receiving. System operators aggressively reuse frequencies within a TDMA system and, as a result, neighbor cell servers often transmit on the same channel frequencies. Because the control channels of each cell server are the same frequency, and due to the very close proximity of the adjacent cells servers, the subscriber units regularly encounter interference on the receive side. That is to say, they often receive transmissions from more than one cell server at any given time. To differentiate each server, the system utilizes “color codes.” The transceiver subscriber units monitor the transmitted color code information associated with the transmitted signal to quickly identify which cell server is the source of the transmitted signal.

If the subscriber unit misses the transmitted color code information associated with the transmitted signal, then the subscriber unit may not be able to differentiate the particular source of the transmitted signal from one of the plurality of neighbor cell servers. This is especially true when initially connecting to the Primary Control Channel (PCCH) of a cell server. The subscriber unit may mistakenly connect to the PCCH of the wrong cell server (i.e., cell server with the same carrier number but different color code.) Even though it connected to the PCCH of a site, the transceiver subscriber unit will most likely experience trouble when trying to decode the data—primarily because of interference from the other server operating on the same frequency. As a result, it will read erroneous data from the slot. One example of this erroneous data is the PCCH channel specifier and the Broadcast Control Channel (BCCH) specifier. The subscriber unit will therefore not be able to connect to the BCCH and will consequently fall off the network and lose service.

As will be discussed in detail below, a new and novel method utilized by the subscriber unit 107 to connect with the system 100, in accordance with an embodiment of the present invention, solves the problem to assure that the color code information utilized by the subscriber unit 107 is reliable for system acquisition and cell server switching.

Subscriber Unit

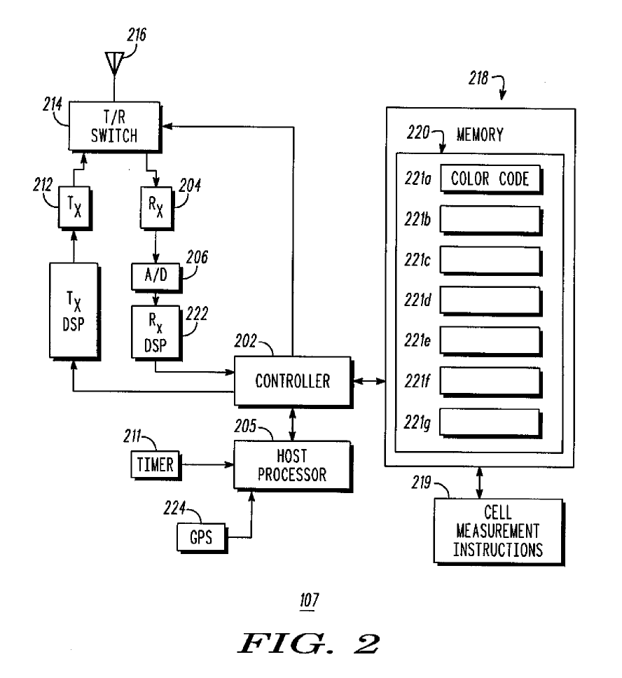

Referring to FIG. 2, a block diagram of the subscriber unit 107 is shown, in accordance with an embodiment of the present invention. The subscriber unit 107, in this example, is a two-way radio capable of receiving and transmitting radio frequency signals over a communication channel under a TDMA protocol.

The subscriber unit 107 includes an antenna 216 or antenna structure that operates as both an input and an output to couple radio frequency signals between the subscriber unlit 107 and the network 100. The antenna 216 acts as a wireless network interface to allow the subscriber unit 107 to detect the presence of one or more available cell servers 102, 103, 104 and communicate with one of the detected cell servers 102, 103, 104. The subscriber unit 107 includes a transmitter 212 and a receiver 204. The transmitter 212 and receiver 204 are coupled via an antenna switch 214 to the antenna 216. For transmit operations, the antenna switch 214 couples the transmitter 212 to the antenna 216. Similarly, for receive operations, the antenna switch 214 couples the antenna 216 to the receiver 204.

The receiver 204 is inter-coupled and interactively operates with a processor 205. The processor 205 is a known processor-based element with functionality that will depend on the specifics of the air interface with the network in communication. The processor 205 is able to execute program instructions stored in a memory 218 and to store data received from the receiver 204 in the memory 218. A controller 202 switches the antenna switch 214 between transmit and receive modes according to instructions stored in the memory 218 and executed by the processor 205. These instructions include a neighbor cell measurement scheduling algorithm 219 as will be discussed in more detail below. The processor 205 and controller 202 can be separate, discrete components or can be a single integrated unit. The processor 205 may include one or more generally available microprocessors, digital signal processors, and other integrated circuits depending on the responsibilities of the controller 202 with respect to signal processing duties or other unit features.

The memory 218 comprises any one or any combination of known RAM (Random Access Memory), ROM (Read-Only Memory), EEPROM (Electrically Erasable Programmable ROM), FLASH, or magnetic memory. The memory 218 is used to store various items or programs, an operating system, or software and data, such as caller lists, for execution or use by the processor 205. This operating software when executed by the processor 205 will result in the processor performing the requisite functions of the subscriber unit 107.

A timer module 211, in this example, provides timing information to the host processor 205 to keep track of timed events such as scheduling receive and transmit operations at predefined time slots in a TDMA protocol. Further, the host processor 205 can utilize the time information from the timer module 211 to keep track of scheduling for neighbor cell server transmissions and transmitted color code information.

When a cell measurement is scheduled, the receiver 204, under the control of the host processor 205 and controller 202, monitors cell servers for transmissions. The received transmission is converted to a digital signal by an analog-to-digital converter 206 and provided as input to a digital signal processor (DSP) 222, which provides a power level value for the received transmission and sends this value to the host processor 205.

Additionally, the DSP 222 and the host processor 205 are able to monitor decoded signals from the receiver 204 during a header portion of a predefined time slot in the TDMA protocol. This header portion, as is well known in the art, includes a slot descriptor block (SDB) to identify information associated with the transmission signal in the particular time slot. The SDB includes four bits of color code information to uniquely identify one from up to sixteen different neighbor cell servers that is the source of a transmitted signal in the particular time slot. The host processor 205 keeps track of candidate cell servers in a portion 220 of memory 218. Using this information, e.g., the color code information, as will be discussed in greater detail below, the subscriber unit 107 determines the most appropriate cell server to use as a primary cell server.

TDMA Communication

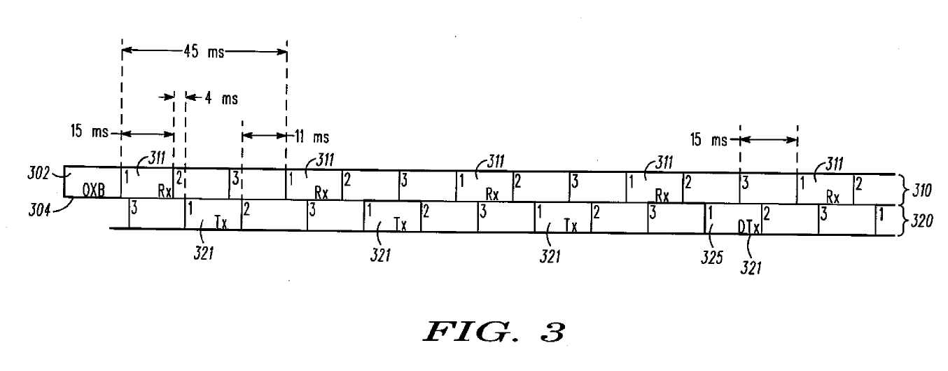

FIG. 3 is a timing block diagram illustrating time slots allocated on receive and transmit channels 310, 320, in an exemplary three slot TDMA system, in accordance with a preferred embodiment of the present invention. The receive and transmit channels 310, 320 are used for communication with a cell server. Although the invention is not limited to any specific TDMA implementation, each channel 310, 320, in this example, is organized into 45 millisecond communication frames of three 15 millisecond time slots. On the receive channel 310, a receive slot 311 occurs every third time slot. Similarly, on the transmit channel 320, a transmit slot 321 occurs every third slot. There is a four milliseconds time delay between the sequence of time slots on the receive and transmit channels. Consequently, there is a 4 millisecond delay between a receive time slot 311 and a subsequent transmit time slot 321, and an 11 millisecond time duration between a transmit time slot 321 and a subsequent receive time slot 311.

In this example, the subscriber unit transceiver 107 receives communication from the base station 102 on each receive slot 311. A portion 302 of the transmission from the base station 102 may include control information used by the subscriber unit 107 for synchronization and other control purposes. Typically, this is the header portion of the time slot and it includes a SDB that contains the color code 304 information associated with the transmitted signal in the time slot.

The subscriber unit 107 transmits information to the base station 102 using the transmit slots 321 as needed. Ordinarily, for power consumption reduction purposes, the subscriber unit does not transmit to the base station when there is no information to be transmitted. However, as in most TDMA systems, regular transmissions from the subscriber unit 107 are needed in order to maintain a communication session with the base station 102.

According to one embodiment of the invention, a subscriber unit 107 attempts to locate a particular base station 102 as a primary cell server, based on the quality of communication signals expected between the subscriber unit 107 and the particular base station. Ordinarily, signal quality is determined by measuring the signal strength of transmitted signals from nearby cell servers 102, 103, 104. This information is used to determine the appropriate cell server to serve as the primary cell server. Each cell server is typically monitored for a duration long enough to monitor the color code information and to properly characterize the quality of signal transmitted. Additionally, it is desirable to monitor each neighbor cell server for comparable time periods such that proper weighting is accorded to the relative signal quality of each. Preferably, multiple cell measurements are taken over several time slots in order to determine the reliability of the received information.

From the arrangement of receive and transmit time slots shown, it can be seen in FIG. 3 that when receiving and transmitting partially overlap the same time frame, there is a short time slot of only eleven milliseconds, which is available for taking neighbor cell measurements. When the subscriber unit 107 is not transmitting during a particular frame, such as at time slot 325, a full time slot of 15 milliseconds is available for taking neighbor cell measurements. It is generally desirable, therefore, to not only capture the color code information but to also have a full time slot to measure the quality of a transmitted signal.

Referring back to FIG. 2, in this example, it can be seen that the portion 220 of memory 218 has seven memory locations 221a-g. As explained in the preceding paragraphs above, the color code values differentiate one cell server from another nearby cell server. In accordance with certain embodiments, the memory stores seven consecutively received color codes 304, one each, in the seven memory locations 221a-g. The invention implements a smart algorithm on the subscriber unit side (either on the host processor 205 or the receive DSP 222 or a combination of both), whereby the subscriber unit 107 detects an anomaly in the received color codes and continues scanning, for instance, to the next carrier in a number cell list contained within the memory 218 in response to detecting the anomaly. In an alternate embodiment, the subscriber unit 107 connects to the cell server designated by the majority of color codes received. In practice, the received color codes are not necessarily all stored in memory at the same time, but instead are compared to each other one at a time as each is received.

In one embodiment of the present invention, the receive DSP 222 is used to determine the primary cell server to which the subscriber unit will connect to. In this embodiment, the receive DSP 222 implements a majority vote scheme where it receives seven channel quality indicators, including color codes 304. The color codes are stored in memory 218. The channel quality indicators are ten compared and the receive DSP 222 discards the channel quality indications with the wrong color code before sending them up to the host. For example, assume there are two sites with carrier number 0x123 and color codes 0xA and 0xB in close proximity to each other. The receive DSP 222, according to the present example, will collect seven readings of the channel quality at its current geographic location. Now suppose six of those readings are with color code 0xA and one is with color code 0xB. Since more readings are received from the site with color 0xA, it can be assumed that the subscribe unit is in an area that is better served by that site than by the adjacent site with color code 0xB. Per the majority vote scheme, the receive DSP 222 will discard the single erroneous channel quality reading. Subsequently, the subscriber unit 107 is able to connect to the proper PCCH. Assuming that it already connected to the PCCH with color code 0xB, it can reject this connect event and continue until it can connect with the PCCH with color code 0xA.

Alternatively, the host processor 205 can implement an algorithm 219 where upon detection of successful channel quality indications with multiple separate color code values, it decides to completely reject this carrier number for camping and restarts scanning with the next most suitable candidate site for reselection. As in the above scenario, it is assumed that the receive DSP 222 forwards the seven readings to the host processor 205, This is followed by a successful connect to the PCCH indication on the site with color code 0xB. In the majority of the instances, the host processor 205 may already know the correct color code for the site. For example:
1. If the subscriber unit had changed cells while engaged in a call (via Handover, Dispatch or PD Reconnection); or
2. If the reason to connect to the PCCH is due to reselection, the host knows the correct color code (since the site was in its number cell list)
   In such cases, the host processor 205 may easily reject the Connect to the PCCH indication and re-start the scanning process. There are, of course, other cases where the host may not be aware of the color code. For example:
1. If the subscriber unit is connecting to the PCCH because of power-up; or
2. If the subscriber unit is returning to service after being out of service.

### In such case, the host may also implement the majority vote scheme explained above.

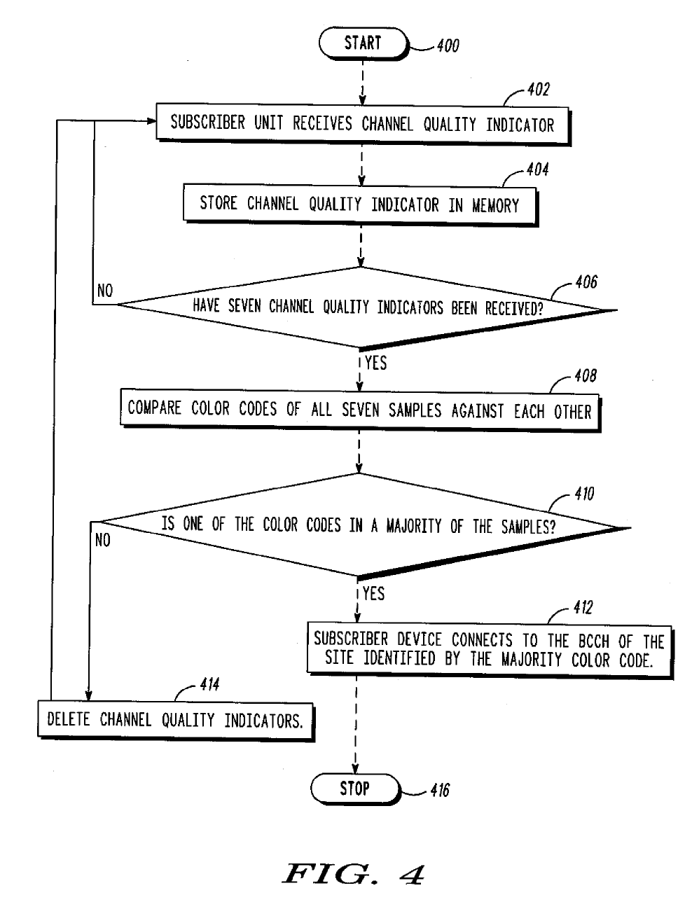

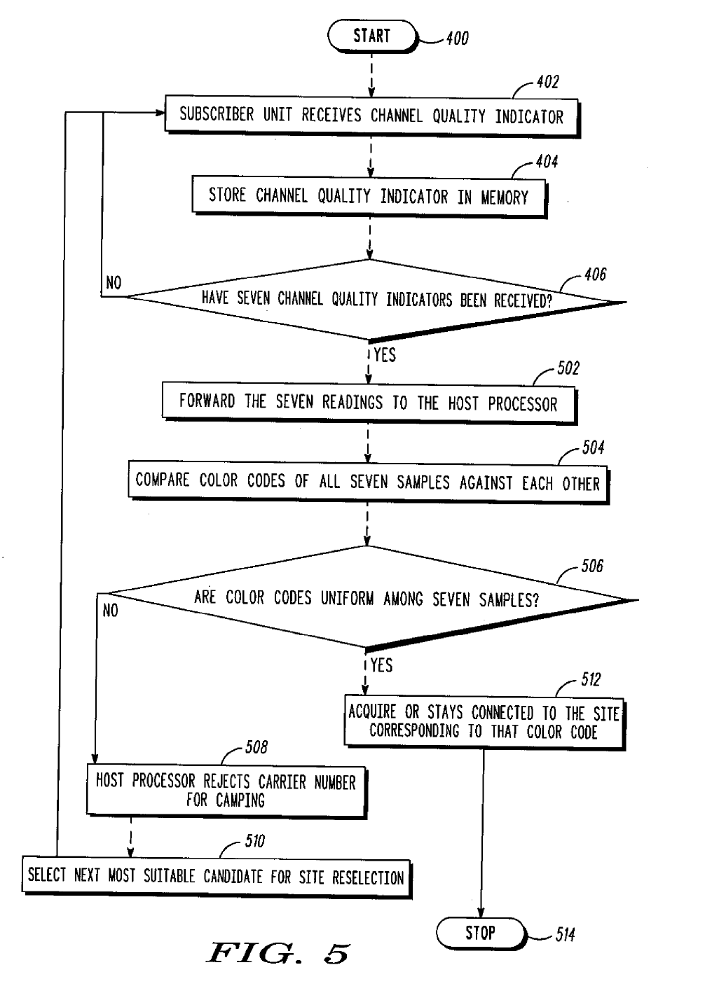

Referring now to FIGS. 4 and 5, an exemplary operational sequence will be discussed for the subscriber unit 107 operating in the system 100, according to an embodiment of the present invention. FIG. 4 illustrates a method for processing color code information and quality measurements of transmitted signals from nearby cell servers utilizing a DSP 222. FIG. 5 illustrates a method for processing color code information and quality measurements of transmitted signals from nearby cell servers utilizing a host processor 205.

The type of system configuration, as discussed above and shown in FIG. 1, is becoming more popular, and is very common in certain markets. Although it allows aggressive reuse of frequencies in a coverage area of the system 100, there is a possibility that a subscriber unit 107 may not be able to distinguish between neighbor cell servers 102, 103, 104, during a quality measurement of a transmitted signal from one of the neighbor cell servers 102, 103, 104. The level of quality of this measurement may qualify a candidate neighbor cell server for possible initial connection or, if already connected to a cell server, switch-over to a new cell server. For this reason, the color code information associated with a quality measurement must be validated to ensure that the source of the transmitted signal is qualified to serve as the cell server that will provide coverage for the subscriber unit.

The process illustrated in FIG. 4 begins at step 400 and moves directly to step 402, where a subscriber unit receives a channel quality indicator, or sample, that includes a color code value uniquely identifying one of a plurality of cell server. The channel quality indicator is stored in memory in step 404. In step 406, a check is performed to determine whether or not seven channel quality indicators have been received. If the answer is no, the flow moves back up to step 402, where anther channel quality indicator is received. If the answer to step 406 is yes, the flow moves to step 408, where one of the color code values is selected based on a determination of a lowest error value calculated by using two or more of the received color code values. In one embodiment, the color codes of all seven samples are compared against each other to determine which color code is present in the greatest number of channel quality indicators received. In this embodiment, in step 410, it is determined whether or not one of the color codes is a majority. If one color code appears in the seven samples more than any other color code, the flow moves to step 412, where the subscriber device connects to the BCCH of the site identified by the color code determined to be in the majority of channel quality indicators received. The flow then stops at step 416. However, if no color code is in the majority of channel quality indicators received in step 402, the channel quality indicators are deleted in step 414 and the flow moves back to step 402.

In another embodiment of the present invention, a color code is selected by determining a signal quality of each of the received samples and weighing each color code value by the signal quality. In this embodiment, the color code value includes an estimate of signal quality. In yet another embodiment, a history of received and/or selected color code values is stored in memory 218 and the color code is selected by comparing at least one of the received color code values to a history of color code values. In an alternative embodiment of the present invention, the subscriber unit 107 includes a GPS antenna 122 that is used for determining a location of the subscriber unit 107. The subscriber unit can then use the location and a neighbor cell server list to calculate a distance from the subscriber unit to a known location of at least one cell server. The subscriber unit 107 can then compare at least one of the received color code values to a known color code value associated with the at least one cell server to determine whether or not it received the correct color code. If not, it can open up the receiver 204 to receiver more samples. If it matches, it can select one of the received color code values that matches one of the neighbor cell servers based on the proximity of the cell server. In still another embodiment, the subscriber unit can select at least two neighbor cell servers from a neighbor cell list and then select a second received color code value corresponding to a second one of the at least two neighbor cell servers in the neighbor cell list. This selection can be based on a next-best determined proximity, where next-best can be a based on proximity to the subscriber unit or on a better signal quality measurement to that cell server.

The process illustrated in FIG. 5. shows the steps followed by one embodiment of the present invention where the algorithm is performed on the host processor The flow begins and follows the same steps 402-406 as in FIG. 4 above. However, in step 502, the DSP forwards the seven readings to the host processor. The host processor, in step 504, analyzes the forwarded readings and in step 506 checks for uniformity in color codes. If there is non-uniformity, i.e., separate color code values, amongst the seven color codes, the process moves to step 508, where the host processor implements an algorithm that rejects the carrier number for camping and, in step 510, selects the next most suitable candidate for site reselection. The process flow then moves back up to step 402 where new samples are received. If, however, the determination in step 506 finds that all the color codes are the same, the subscriber unit acquires Or stays connected to the site corresponding to that color code in step 512. The process ends at step 514.

The present invention, according to certain embodiments, is advantageous in that it provides an efficient and inexpensively-implemented significant improvement in the process of validating color code information associated with a monitored signal from cell servers. The invention provides to subscriber units the information necessary, and method of determining, proper base acquire and cell server switching decisions.

Although specific embodiments of the invention have been disclosed, it will be understood by those having ordinary skill in the art that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method with a subscriber unit operating in a communication system, the system having a plurality of cell servers in a coverage area, the method comprising:
receiving a plurality of signal samples that each include a color code value uniquely identifying one cell server of a plurality of cell servers transmitting signals in a coverage area; and
selecting one of the received plurality of color code values based on a determination of a likeliest source of the received signal samples calculated by comparing to each other of the plurality of received color code values.

2. The method according to claim 1, wherein the determination of a likeliest source of the received signal samples comprises:
determining which received color code value is present more than any other of the received color code values.

3. The method according to claim 1, wherein the determination of a likeliest source of the received signal samples comprises:
comparing each received color code value against each other received color code value; and
determining that all of the plurality of received color code values are the same.

4. The method according to claim 1, wherein the determination of a likeliest source of the received signal samples comprises:
comparing each received color code value against each other received color code value; and
determining that a majority of the plurality of received color code values are the same.

5. The method according to claim 1, wherein the determination of a likeliest source of the received signal samples comprises:
determining a signal quality of each of the received samples; and
weighing each color code value by the signal quality.

6. The method according to claim 5, wherein the color code value includes an estimate of signal quality.

7. The method according to claim 1, wherein the determination of a lowest error value comprises:
comparing at least one of the received color code values to a history received of color code values.

8. The method according to claim 1, wherein the determination of a likeliest source of the received signal samples comprises:
determining a location of the subscriber unit;
calculating a distance from the subscriber unit to a known location of at least one cell server; and
comparing at least one of the received color code values to a known color code value associated with the at least one cell server.

9. The method according to claim 1, wherein the determination of a likeliest source of the received signal samples comprises:
determining a location of the subscriber unit; and
comparing at least one of the received color code values to a history of color code values previously received approximately at the determined location of the subscriber unit.

10. The method according to claim 1, wherein the selecting one of the plurality of received color code values comprises:
determining a location of the subscriber unit; and
determining a proximity from the subscriber unit to at least two neighbor cell servers in a neighbor cell list; and
selecting one of the received color code values that matches one of the at least two neighbor cell servers based on the determined proximity thereto.

11. The method according to claim 10, further comprising:
selecting the at least two neighbor cell servers from a neighbor cell list; and
selecting a second received color code value corresponding to a second one of the at least two neighbor cell servers in the neighbor cell list, the selection based on a next best determined proximity.

12. The method according to claim 1, wherein:
each of the plurality of samples is transmitted from a different one of the plurality of cell servers.

13. A subscriber unit for operating with a cellular communication system, the subscriber unit comprising:
an input for receiving a plurality of samples that each include a color code value uniquely identifying one cell server in a plurality of cell servers transmitting signals in a coverage area;
a processor communicatively coupled to the input; and
a memory, communicatively coupled to the processor, the memory storing computer instructions for operating the processor, the instructions comprising instructions to:
select one of the received plurality of color code values based on a determination of a likeliest source of the received signal samples calculated by comparing to each other of the plurality of received color code values.

14. The subscriber unit according to claim 13, wherein the instructions further comprise instructions to:
compare each received color code value against each other received color code value; and
determine that all of the plurality of received color code values are the same.

15. The subscriber unit according to claim 13, wherein the instructions further comprise instructions to;
compare each received color code value against each other received color code value; and
determine that a majority of the plurality of received color code values are the same

16. The subscriber unit according to claim 13, wherein the instructions further comprise instructions to:
determine a signal quality of each of the received samples; and
weigh each color code value by the signal quality.

17. The subscriber unit according to claim 16, wherein the color code value includes an estimate of signal quality.

18. The subscriber unit according to claim 13, wherein the instructions further comprise instructions to:
compare at least one of the received color code values to a history of received color code values.

19. The subscriber unit according to claim 13, wherein the instructions further comprise instructions to:
determine a location of the subscriber unit;
calculate a distance from the subscriber unit to a known location of at least one cell server; and
compare at least one of the received color code values to a known color code value associated with the at least one cell server.

20. The subscriber unit according to claim 13, wherein the instructions further comprise instructions to:
determine a location of the subscriber unit; and
compare at least one of the received color code values to a history of received color code values previously received at the determined location of the subscriber unit.
